(19) United States
(12) Patent Application Publication
(10) Pub. No.: US 2026/0116056 A1
(43) Pub. Date: Apr. 30, 2026

(54) POLYPROPYLENE BLISTER PACKAGING

(71) Applicant: AMCOR FLEXIBLES NORTH AMERICA, INC., Neenah, WI (US)

(72) Inventors: TYLER J. THEOBALD, Neenah, WI (US); Michael D. PRISCAL, Neenah, WI (US); Kevin P. NELSON, Appleton, WI (US); Yuan LIU, Apex, NC (US)

(21) Appl. No.: 19/123,649

(22) PCT Filed: Nov. 8, 2022
(86) PCT No.: PCT/US2022/049219

§ 371 Date: Apr. 23, 2025

(51) Int. Cl. B32B 27/08; B32B 3/30; B32B 27/26; B32B 27/32

(52) U.S. Cl. CPC B32B 27/08; B32B 3/30; B32B 27/26; B32B 27/325; B32B 2250/24; B32B 2270/00; B32B 2307/31; B32B 2307/738; B32B 2439/80

(57) ABSTRACT

A system for forming a blister package includes a thermoformable film and a lidding film. The thermoformable film has a thermoformable film exterior layer and a thermoformable film interior layer. The thermoformable film exterior layer includes at least 50% by weight polypropylene. The thermoformable film interior layer includes at least 50% by weight polypropylene and (a) a tackifier and/or (b) a cyclic olefin copolymer. The lidding film includes a lidding film exterior layer, a seal layer, and a lidding film interior layer between the lidding film exterior layer and the seal layer. The lidding film exterior layer includes at least 50% polypropylene. The lidding film interior layer includes at least 50% polypropylene and a tackifier. The seal layer includes a polyolefin plastomer.

### FIELD

This disclosure relates generally to films, such as recyclable films, suitable for thermoforming into packaging components.

### INTRODUCTION

Polypropylene is a highly adaptable semi-crystalline material that is readily recycled. However, polypropylene is not typically used for thermoforming in form/fill/seal packaging lines due to its narrow thermoforming temperature window. More amorphous materials are typically employed in such thermoforming due to their wider thermoforming temperature windows.

### SUMMARY

The present disclosure describes, among other things, systems and methods for forming blister packages. A film comprising at least 50% by weight polypropylene may be thermoformed and sealed to a lidding film to produce a blister pack. The lidding film may comprise more than 50% by weight polypropylene. The blister pack may be recyclable.

The thermoformable film may comprise a layer comprising at least 50% polypropylene and a tackifier, a cyclic olefin copolymer, or a tackifier and a cyclic olefin copolymer. The tackifier and/or the cyclic olefin copolymer broadens the thermoforming temperature window, relative to a layer consisting essentially of polypropylene, and may improve sag resistance. Such films are suitable for practical use in thermoforming, particularly on form/fill/seal packaging lines which have short dwell times.

In one or more aspects, the present disclosure describes a system for forming a blister package. The system includes a thermoformable film and a lidding film. The thermoformable film comprises a thermoformable film exterior layer and a thermoformable film interior layer. The thermoformable film exterior layer comprises at least 50% by weight polypropylene. The thermoformable film interior layer comprises at least 50% by weight polypropylene and (a) a tackifier and/or (b) a cyclic olefin copolymer. The lidding film comprises a lidding film exterior layer, a lidding film interior layer, and a seal layer. The lidding film exterior layer comprises at least 50% by weight polypropylene. The lidding film interior layer comprises at least 50% by weight polypropylene and a tackifier. The seal layer comprises a polyolefin plastomer.

Methods for forming a blister pack include thermoforming a tray from the thermoformable film and heat sealing the lidding film to the tray to form the blister pack.

Blister packs may include a tray formed from the thermoformable film and a lidding formed from the lidding film and sealed to the tray.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1-7 are schematic cross-sectional views of embodiments of films according to the present disclosure.

FIG. 8 is a schematic perspective view of thermoformed base component including 10 cavities according to an embodiment of the present disclosure.

FIG. 9 is a schematic top view of an embodiment of a thermoformed base component showing 12 cavities and a flange.

FIG. 10 is a schematic cross-sectional view of an embodiment of a package including thermoformed base component, a product and a lid component.

FIG. 11 is a schematic of a cross-section of an embodiment of a lid component for a packaged product.

FIGS. 12A-D and 13A-D are images of films as described in the Examples.

The drawings show some but not all embodiments. The elements depicted in the drawings are illustrative and not necessarily to scale. The same (or similar) reference numbers denote the same (or similar) features throughout the drawings. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### DETAILED DESCRIPTION

This disclosure relates to, among other things, films comprising polypropylene layers suitable for thermoforming. The films comprise one or more layers comprising at least 50% polypropylene and a tackifier and/or a cyclic olefin copolymer. Such films may have properties suitable for thermoforming in form/fill/seal packaging equipment, and such properties include a broadened thermoforming temperature window and sag resistance.

Polypropylene is a semicrystalline material that has a narrow thermoforming temperature window. As described herein, adding a tackifier may allow for more polypropylene chain movement at temperatures near the Tg of the tackifier, making the polypropylene film or layer more stretchable. The result of tackifier addition may extend the lower end of the thermoforming temperature window. In some embodiments, a film or layer described herein may include a crosslinker. A crosslinker may serve to enhance the melt strength of the material, which may increase the upper end of the thermoforming temperature window. The crosslinker may also serve to increase the number of times a film or article may be reused, further enhancing recyclability.

Adding a cyclic olefin copolymer to a polypropylene film or layer described herein may broaden the thermoforming temperature window. Adding a cyclic olefin copolymer may improve sag resistance. In some embodiments, the addition of a cyclic olefin copolymer broadens the thermoforming temperature window and improves sag resistance relative to a film or layer consisting essentially of polypropylene. The addition of a cyclic olefin copolymer may improve barrier properties of a polypropylene film or layer. However, the overall amount of cyclic olefin copolymer in the layer, film, or package is preferably kept sufficiently low to allow the film or package comprising a cyclic olefin copolymer containing layer to be recyclable.

### Polypropylene

The films, layers, and packages described herein comprise polypropylene (PP). As used herein, “polypropylene” is a polymer formed from a propylene monomer or a propylene monomer and one or more other monomers. The PP may be a homopolymer or a copolymer. The PP may be unmodified or modified. For example, the PP may be modified by, for example, derivatization after polymerization to add functional groups or moieties along the polymeric chain.

In some embodiments, the PP is a homopolymer. In some embodiments, the PP is a copolymer. In some embodiments, the PP is a random copolymer. In some embodiments, the PP is blend of a homopolymer and a copolymer. In some embodiments, the PP is a blend of a homopolymer and a random copolymer.

The PP may contain at least 50% propylene by weight, such as at least 60% PP by weight, at least 70% PP by weight, at least 90% PP by weight, or about 100% PP by weight. In some embodiments, PP contains from about 80% PP by weight to about 99.5% PP by weight.

In some embodiments, the PP cumulatively contains less than 50% by weight comonomers. In some embodiments, the PP contains 40% by weight or less comonomer, 30% by weight or less comonomer, 20% by weight or less comonomer, or 10% by weight or less comonomer.

In some embodiments, the PP comprises a comonomer selected from ethylene and alpha-olefins having from 4 to 12 carbon atoms. In some embodiments, the PP comprises ethylene. In embodiments, the PP comprises a comonomer selected from ethylene and alpha-olefins having from 4 to 12 carbon atoms at a weight percent from about 0.1% to about 20%, such as from about 0.5% to about 15%, about 0.5% to about 10%, about 0.5% to about 8%, 1% to about 15%, about 1% to about 10%, about 1% to about 8%, 2% to about 15%, about 2% to about 10%, or about 2% to about 8%.

The films, layers, and packages comprising PP may have any suitable amount of PP. In some embodiments, the films, layers, or packages comprise 50% by weight or more (at least 50%) PP, such as at least 60% by weight PP, at least 70% by weight PP, at least 80% by weight PP or at least 90% by weight PP. In some embodiments, the films, layers, and packages comprise less than 95% by weight PP. In some embodiments, the films, layers, and packages comprise from about 50% by weight PP to about 95% PP, such as from about 50% PP to about 90% PP, from about 50% PP to about 80% PP, from about 50% PP to about 70% PP, from about 50% to about 60% PP, from about 60% by weight PP to about 95% PP, from about 60% PP to about 90% PP, from about 60% PP to about 80% PP, from about 60% PP to about 70% PP, from about 70% by weight PP to about 95% PP, from about 70% PP to about 90% PP, from about 70% PP to about 80% PP, from about 80% by weight PP to about 95% PP, or from about 80% PP to about 90% PP.

In some embodiments, PP comprise isotactic PP. The isotactic PP may be mostly, highly, or predominantly isotactic PP. The layers, films, or packages described herein may comprise PP having any suitable molecular weight for forming a film or layer. Mass flow rates may relate to molecular weight. In embodiments, the PP has a mass flow rate of from about 0.5 g/10 min (grams per 10 minutes) to about 10 g/10 min, such as from about 0.6 g/10 min to about 8 g/10 min, from about 0.8 g/10 min to about 6 g/10 min, or from about 2 g/10 min to about 4 g/10 min. Mass flow rate may be measured according to ASTM D1238-20 (Sep. 3, 2020), Standard Test Method for Melt Flow Rates of Thermoplastics by Extrusion Plastometer.

An example of a PP homopolymer that may be used in a layer, film, or package described herein is 6021N polypropylene homopolymer (Braskem INSPIRE 6021N). An example of a polypropylene random copolymer that may be used in a blend or layer described herein is 6232 polypropylene copolymer (e.g., from Total or TotalEnergies).

In some embodiments, at least some of the PP in a layer, film, or package described herein is an impact polypropylene. As used herein, “impact polypropylene” is a copolymer produced through the polymerization of propylene and ethylene, which has a heterophasic, predominantly amorphous structure inside a polypropylene homopolymer matrix. Impact PP may be produced in any suitable manner. In some embodiments, impact PP is produced in series reactors where the rubber phase is produced in one reactor and the homopolymer is produced in the other. The characteristics of the resin depend not only on the rubber content but also on the sizes of the rubber domains.

Impact PP may have any suitable mass flow rate. In some embodiments, impact PP has a mass flow rate of from about 0.4 g/10 min to about 0.8 g/10 min.

An example, of an impact polypropylene is a propylene homopolymer containing a co-mixed propylene random copolymer phase that has an ethylene content of 45% to 65%. Examples of suitable impact PP that may be included in the blends or layers include Total (TotalEnergies) 4170, LyondellBasell Pro-fax 7823, and LyondellBasell Adflex Q 100F. Total 4170 has the following properties: mass flow rate (MFR)=0.8 g/10 min; density=0.905 g/cm³; Tm=160-165° C. Profax 7823 has the following properties: MFR=0.45 g/10 min; density=0.90 g/cm³. Adflex Q 100 F has the following properties: MFR=0.6 g/10 min; density=0.88 g/cm³; Tm=142° C.

In some embodiments, the blends or layers comprise at least 5% impact PP by weight, such as at least 10% impact PP by weight, at least 15% impact PP by weight, at least about 20% impact PP by weight, at least about 25% impact PP by weight, at least about 30% impact PP by weight, or at least about 35% impact PP by weight. In some embodiments, the blends or layers comprise less than 50% impact PP by weight, such as less than 40% impact PP by weight. In some embodiments, the blends or layers comprise about 10% to about 30% impact PP by weight, about 5% to about 35% impact PP by weight, or 10% to about 25% impact PP by weight, or about 10% to about 20% impact PP by weight.

### Cyclic Olefin Copolymer

The films, layers, and packages described herein may comprise a cyclic olefin copolymer (COC). A COC is a copolymer made by polymerization of at least one α-olefin comonomer with at least one cyclic aliphatic comonomer (and/or at least one cyclic aromatic comonomer) having a reactive olefin portion thereof (i.e., forming a portion of the cyclic structure) or a reactive olefin portion thereon (e.g., an α-olefin substituent on the cyclic structure). In some embodiments, a COC is formed from α-olefin comonomers including C₂-C₂₀ α-olefin, such as C₄-C₁₂ aliphatic α-olefin comonomers. In some embodiments, a COC is formed from α-olefin comonomers comprising one or more of C₄, C₆, C₈, C₁₀, and/or C₁₂ α-olefin comonomers. In some embodiments, a COC is formed from α-olefin comonomers comprising norbornene. In some embodiments, a COC is formed from polymerization of propylene and an α-olefin comonomer. In some embodiments, a COC is a propylene/norbornene copolymer. In some embodiments, a COC is formed from polymerization of ethylene and an α-olefin comonomer. In some embodiments, a COC is an ethylene/norbornene copolymer. In some embodiments, an ethylene-norbornene COC comprises 20 mole % to 70 mole % ethylene and 30 mole % to 60 mole % norbornene.

Examples of commercially available COCs are those from Topas Advanced Polymers, which are amorphous, transparent copolymers of ethylene with norbornene made by polymerization with a metallocene catalyst. These commercially available COCs reportedly have high transparency and gloss, excellent moisture barrier and aroma barrier properties, a variable glass transition point between 50° C. and 178° C. (such as from 65° C. to 178° C.), high stiffness, high strength, excellent biocompatibility and inertness and easy thermoformability. COCs may be blended with PP.

The layers of films comprising a COC may comprise any suitable amount of COC. In some embodiments, the COC is present a layer in an amount between about 5% by weight and about 35% by weight, such as from about 10% by weight to about 30% by weight, from about 15% by weight to about 25% by weight, or about 20% by weight. In some embodiments, the layers of films comprising a COC comprises at least 50% PP by weight.

### Tackifier

The blends and layers described herein may comprise any suitable tackifier. For purposes of this disclosure “tackifier” and “hydrocarbon resin” are used interchangeably. The tackifier may be present in the blends and layers in any suitable amount. In embodiments, the tackifier is present in a blend or layer in an amount of 5% by weight or greater (“at least 5%”), 10% by weight or greater, 15% by weight or greater, or 20% by weight or greater. In embodiments, the tackifier is present in a blend of layer in an amount of 60% by weight or less, 50% by weight or less, or 40% by weight or less. In embodiments, the blend or layer comprises from 5% to 60% tackifier by weight, such as from 5% to 50% tackifier by weight, 5% to 40% tackifier by weight, 10% to 60% tackifier by weight, 10% to 50% tackifier by weight. 10% to 40% tackifier by weight. 15% to 60% tackifier by weight, 15% to 50% tackifier by weight, 15% to 40% tackifier by weight, 20% to 60% tackifier by weight, 20% to 50% tackifier by weight, 20% to 40% tackifier by weight, 10% to 25% tackifier by weight, 15% to 20% tackifier by weight, or the like.

The blends or layers may include any suitable tackifier. Suitable tackifiers include aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, cycloaliphatic/aromatic at least partially hydrogenated hydrocarbon resins, polyterpene resins, terpene-phenol resins, rosin esters, rosin acids, grafted resins, and mixtures of two or more of the foregoing. The hydrocarbon resins may be polar or apolar.

The tackifier may be a low molecular weight product (molecular weight less than about 10,000 Daltons) produced by polymerization from coal tar, petroleum, citrus or turpentine feed stocks.

A tackifier may comprise any of those hydrocarbon resins disclosed in U.S. Pat. No. 6,432,496, issued Aug. 13, 2002, or in U.S. Patent Application 2008/0286547, published Nov. 20, 2008, both of which are incorporated in their entireties in this application by this reference. More specifically, as a non-limiting example, the tackifier may include petroleum resins, terpene resins, styrene resins, cyclopentadiene resins, saturated alicyclic resins or mixtures of such resins. Additionally, as a non-limiting example, the tackifier may comprise hydrocarbon resin derived from the polymerization of olefin feeds rich in dicyclopentadiene (DCPD), from the polymerization of olefin feeds produced in the petroleum cracking process (such as crude C9 feed streams), from the polymerization of pure monomers (such as styrene, alpha-methylstyrene, 4-methylstyrene, vinyltoluene or any combination of these or similar pure monomer feedstocks), from the polymerization of terpene olefins (such as alpha-pinene, beta-pinene or d-limonene) or from a combination of such. The hydrocarbon resin may be fully or partially hydrogenated. Specific examples of hydrocarbon resins include but are not limited to Plastolyn® R1140 Hydrocarbon Resin available from Synthomer plc (Essex, UK), Regalite® T1140 available from Synthomer plc (Essex, UK), Arkon® P-140 available from Arakawa Chemical Industries, Limited (Osaka, Japan) and Piccolyte® S135 polyterpene resins available from Pinova, Inc. (Brunswick, GA).

### Crosslinker

The layers, films, or packages described herein may comprise a crosslinker or may be formed from a blend comprising a crosslinker. In some embodiments, the layers, films, or packages do not comprise a crosslinker. In some embodiments, the layers, films, or packages comprise a reversible crosslinker. Suitable reversible crosslinkers include crosslinkers that form crosslinks through ionic, hydrophobic, or other secondary interactions rather than through covalent bonds. In some embodiments, crosslinkers may increase melt viscosity and reduce sagging of a film or layer by increasing entanglements via long chain branching.

In embodiments, the crosslinker comprises an organic peroxide. A coagent may be used with the organic peroxide. The coagent may be used to reduce scission and enhance crosslinking. Examples of organic peroxides and coagents are described in, for example, U.S. Pat. No. 6,987,149 and Romani et al. (February 2002), Monitoring the chemical crosslinking of propylene polymers through rheology, Polymer 43 (4): 1115-1131, which are hereby incorporated herein by reference in their respective entireties to the extent they do not conflict with the disclosure presented herein.

In embodiments, the crosslinker produces long chain branched polypropylene by extrusion (grafting). See, for example, Didier Graebling (2002), Synthesis of Branched Polypropylene by a Reactive Extrusion Process. Macromolecules, American Chemical Society, 35(12): 4602-4610, which is hereby incorporated herein by reference in its entirety to the extent it does not conflict with the disclosure presented herein.

In embodiments, the crosslinker produces long chain branched isotactic polypropylene. See, for example, Weng et al. (2002), Long Chain Branched Isotactic Polypropylene, Macromolecules 35 (10): 3838-3843, DOI: 10.1021/ma020050j, which is hereby incorporated herein by reference in its entirety to the extent it does not conflict with the disclosure presented herein.

In embodiments, the crosslinker produces long chain branched polypropylene via irradiation. See, for example, Krause et al. (5 Jan. 2006), Long-chain branching of polypropylene by electron-beam irradiation in the molten state, Journal of Applied Polymer Science, 99 (1): 260-265 and Auhl et al. (11 Nov. 2004), Long-Chain Branched Polypropylenes by Electron Beam Irradiation and Their Rheological Properties, Macromolecules 37 (25): 9465-9472, which are hereby incorporated herein by reference in their respective entireties to the extent they do not conflict with the disclosure presented herein.

In embodiments, the crosslinker comprises an ionic crosslinker. In embodiments, the crosslinker is an ionic crosslinker as described in U.S. Pat. No. 9,045,615, which is hereby incorporated herein by reference in its entirety to the extent it does not conflict with the disclosure presented herein.

Examples of suitable crosslinkers that may be used include cross-linking monomers; reactive oligomers; polyisocyanate oligomers; functional, cross-linkable polymers; derivatives of ethylene glycol di(meth)acrylate (such as ethylene glycol diacrylate, di(ethylene glycol) diacrylate, tetra(methylene/ethylene glycol) diacrylate, ethylene glycol dimethacrylate (EDMA), di(ethylene glycol) dimethacrylate (DEDMA), tri (methylene/ethylene glycol) dimethacrylate, tetraethylene glycol dimethacrylate (TEDMA)); derivatives of methylenebisacrylamide (such as N,N.-methylenebisacrylamide, N,N.-methylenebisacrylamide, N,N.-(1,2 dihydroxyethylene) bisacrylamide); formaldehyde-free crosslinking agents (such as N-(1-hydroxy-2,2-dimethoxyethyl) acrylamide); divinylbenzene; divinylether; diallyl phthalate; divinylsulfone and the like.

In some embodiments, the crosslinker is an ionic crosslinker comprising a multivalent metal oxide cross-linking agent, such as lead oxide, magnesium oxide, barium oxide, zinc oxide, manganese oxide, copper oxide, aluminum oxide, nickel oxide or combinations thereof. In some embodiments, the ionic crosslinker comprises zinc hydroxide, aluminum hydroxide, magnesium hydroxide, or other metal hydroxides, such as barium hydroxide, manganese hydroxide, copper hydroxide, and nickel hydroxide. In embodiments, an ionic crosslinker comprises a cross-linking monomer, a reactive oligomer, a polyisocyanate oligomer, a functional, cross-linkable polymer, a derivative of ethylene glycol di(meth)acrylate (such as ethylene glycol diacrylate, di(ethylene glycol) diacrylate, tetra(methylene/ethylene glycol) diacrylate, ethylene glycol dimethacrylate (EDMA), di(ethylene glycol) dimethacrylate (DEDMA), tri(methylene/ethylene glycol) dimethacrylate, tetraethylene glycol dimethacrylate (TEDMA)), a derivative of methylenebisacrylamide (such as N,N.-methylenebisacrylamide, N,N.-methylenebisacrylamide, N,N.-(1,2 dihydroxyethylene)bisacrylamide), a formaldehyde-free cross-linking agent (such as N-(1-hydroxy-2,2-dimethoxyethyl) acrylamide), divinylbenzene, divinylether, diallyl phthalate, divinylsulfone and the like. Combinations of these cross-linking agents can also be used.

In some embodiments, the crosslinker is a zinc diacrylate salt. An example of a zinc diacrylate salt is DYMALINK® 9200 ionomeric diacrylate functional monomer available from Total (TotalEnergies) for modification of polyolefins, such as polypropylene.

The layers, films, or packages described herein, or the blends used to make the layers, films, or packages, may comprise any suitable amount of crosslinker. In embodiments, the crosslinker is present in a blend or layer in an amount of 0.5% by weight or greater (“at least 0.5%”), 1% by weight or greater, 1.5% by weight or greater, or 2% by weight or greater. In embodiments, the crosslinker is present in a blend of layer in an amount of 10% by weight. 7.5% by weight or less, or less or 5% by weight. In embodiments, the blend or layer comprises from 0.5% to 6% crosslinker by weight, such as from 0.5% to 5% crosslinker by weight, 0.5% to 4% crosslinker by weight, 1% to 6% crosslinker by weight, 1% to 5% crosslinker by weight, 1% to 4% crosslinker by weight, 1.5% to 6% crosslinker by weight, 1.5% to 5% crosslinker by weight, 1.5% to 49% crosslinker by weight, 2.0% to 6% crosslinker by weight, 2% to 5% crosslinker by weight. 29% to 4% crosslinker by weight, 1% to 2.5% crosslinker by weight. 1.5% to 2% crosslinker by weight, 1% to 3% crosslinker by weight, or the like.

### Films and Recyclable Films and Packages

The thermoformable films and the lidding films described herein may be fully coextruded or may be produced by other processes such as lamination or coating. Overall, the films described herein may have any suitable thickness. In embodiments, the films may have a thickness from about 4 mil (102 micron) to about 80 mil (2,032 micron), which thicknesses may be suitable for thermoforming. Some packaging applications would benefit from a thermoformable base film that has a thickness from about 8 mil (203 micron) to about 50 mil (1,270 micron). In some embodiments, the film has a thickness from about 8 mil (203 micron) to about 25 mil (635 micron).

The films and packages described herein are preferably suitable for recycling. To be suitable for recycling, the total composition of the film or the package should be suitable for recycling. In embodiments, the film has a total composition suitable for recycling in a process that typically accepts polypropylene-based materials. Some recycling streams that accept PP-based materials may accept mixed polyolefin-based material, such as PP-based and polyethylene-based materials.

The films described herein may be recycled after their primary use is completed. As used herein, the term “suitable for recycling” is meant to indicate that the film can be converted into a new useful item, by means of reprocessing in a polyolefin recycle stream (e.g., recycling streams based on PP). Reprocessing may entail washing, separating, melting and forming, among many other steps. Typically, when plastic packaging is recycled by reprocessing, the material is mechanically chopped into small pieces, melted, mixed and reformed into the new product. If multiple incompatible materials are present in the packaging, interactions occur during reprocessing causing gels, brittle material, poor appearance and generally unusable or poor-quality products. Using the term “recyclable” indicates that these drawbacks are generally not present. Qualification as a recyclable material is not regulated by any specific agencies but can be obtained from specific groups such as Association of Plastic Recyclers (APR) and How2Recycle™. Recyclable films disclosed herein may be suitable for PP-based recycling streams. Introduction of a recyclable film into any of these recycling-by-reprocessing avenues may, in some embodiments, not require additional compatibilizer.

Being suitable for recycling may be obtained by keeping the overall amount of PP in the total composition of the film or package high. Any additives used should be kept to a minimum. Any non-PP-based polymers present may be accompanied by compatibilizers to achieve a composition suitable for recycling.

In some embodiments, the films or packages described herein include 50% or more (“at least 50%”) by weight PP, such as at least 60% by weight PP, at least 70% by weight PP, at least 80% by weight PP, or at least 90% by weight PP.

To further efforts to achieve a total composition that is suitable for recycling, some embodiments of the film or package are free from, or essentially free from, polyester materials. Polyester materials are typically used in films because of thermoforming ease, stiffness and clarity. However, the presence of polyester may greatly hinder the recyclability of the film or package. In some embodiments, the film or package comprises less than 20% by weight polyester, such as less than 10% by weight polyester, less than 5% by weight polyester, or less than 1% by weight polyester.

To further efforts to achieve a total composition that is suitable for recycling, some embodiments of the film or package are free from, or essentially free from, EVOH materials. EVOH is typically used in films because it is a thermoformable oxygen barrier material. However, the presence of EVOH may greatly hinder the recyclability of the film or package. In some embodiments, the film or package comprises less than 10% by weight EVOH, less than 5% by weight EVOH, or less than 1% by weight EVOH.

To further efforts to achieve a total composition that is suitable for recycling, some embodiments of the film or package are free from, or essentially free from, polyamide materials. Polyamide materials are typically used because of thermoforming ease, durability and stiffness. However, the presence of polyamide may greatly hinder the recyclability of the film or package. In some embodiments, the film or package comprises less than 20% by weight polyamide, such as less than 10% by weight polyamide, less than 5% by weight polyamide, or less than 1% by weight polyamide.

The films described herein may be free from polyester, EVOH and polyamide. In some embodiments, the film comprises less than 20% by weight polyester, EVOH and polyamide, cumulatively, such as less than 10% by weight polyester, EVOH and polyamide, cumulatively, less than 5% by weight polyester, EVOH and polyamide, cumulatively, or less than 1% by weight polyester, EVOH and polyamide, cumulatively.

In some embodiments, the film comprises one or more oxygen barrier layers. In embodiments, the oxygen barrier layer is an interior layer of the film. The oxygen barrier layer contains a material that is known to limit the transmission of oxygen through the film. One choice for an oxygen barrier material is EVOH. In some cases, EVOH may be present along with a compatibilizer that allows EVOH to be incorporated into the PP recycling stream.

As used herein, “EVOH” refers to ethylene vinyl alcohol copolymer. EVOH is otherwise known as saponified or hydrolyzed ethylene vinyl acetate copolymer and refers to a vinyl alcohol copolymer having an ethylene comonomer. EVOH is prepared by the hydrolysis (or saponification) of an ethylene-vinyl acetate copolymer. EVOH is commercially available in resin form with various percentages of ethylene. Preferably, ethylene/vinyl alcohol copolymers comprise from about 27-38 mole % ethylene, or even 27-29 mole % ethylene.

The films described herein may comprise one or more tie layers. Tie layers bond dissimilar layers. For example, a tie layer may be used to bond an EVOH layer to a PP layer. The need for tie layers is dependent upon the materials in the adjacent layers. Tie layers based on PP copolymers are typically suitable for films described herein.

### Thermoformable Films

At least one layer of a thermoformable film described herein comprises at least 50% by weight PP and (a) a tackifier and/or (b) a COC. The layer may also comprise a crosslinker. The layer may comprise weight percentages of the different components as described above. In embodiments, the layer is an interior layer of a thermoformable film. As used herein, an “interior” layer of a film is a layer that is between two other layers of the film.

The thermoformable film may further comprise one or more additional layers. In some embodiments, the thermoformable film comprises an exterior layer. The exterior layer forms a surface of the film. The exterior layer may comprise at least 50% PP by weight, such as at least 60% PP by weight, at least 70% PP by weight, at least 80% PP by weight, at least 90% PP by weight, or at least 95% PP by weight. The exterior layer may consist essentially of PP. The exterior layer may comprise 99.9% PP by weight or less. The film may comprise two exterior layers. Each exterior layer may be the same or different. In embodiments, each exterior layer is the same or substantially the same.

In embodiments, the exterior layer comprises a blend of PP and a polyolefin elastomer (POE). In embodiments, the blend comprises at least 50% PP by weight. The exterior layer may comprise any suitable POE. POEs are ethylene-based or propylene-based random copolymers produced from single-site catalysts that bridge the performance gap between conventional polyolefins such as polyethylene or polypropylene and conventional elastomers like ethylene propylene diene monomer (EPDM). See, e.g., Mark, J. (Ed.). (1999). Polymer Data Handbook. Oxford University Press. Any suitable catalyst, such as metallocene catalysts or Ziegler-Natta catalysts, may be used to produce POEs. POEs typically have densities less than 0.886 g/cm³. Ethylene-based POEs may have 65% to 91% by weight ethylene and 9% to 35% by weight linear alpha-olefin (LAO). LAO such as butene-1, hexene-1, or octene-1 may be used. While incorporation of other comonomers and amounts is possible, propylene-based POEs typically have 70% to 90% propylene by weight and 10% to 30% by weight ethylene or butene-1. POEs may be produced by any suitable process, such as solution processes, gas phase reactor processes, and autoclave processes. In some embodiments, the POE is a propylene-based POE. In some embodiments, the POE comprises a propylene random copolymer.

The term “layer,” as used herein, refers to a building block of films that is a structure of a single material type or a homogeneous blend of materials. While the constituents of a layer may be diverse, the composition of a layer is consistent throughout (i.e., the layer is not stratified). Films contain one or more layers that are connected to each other. A layer may contain a single polymer, a blend of materials within a single polymer type (for example, polypropylene) or a blend of various polymer types, may contain metallic materials or other non-polymer materials, and may have additives. Layers may be continuous with the film or may be discontinuous or patterned in comparison to the film. A film has two surfaces, opposite each other. The layer at the surface of a film is not connected to another layer of that film at that surface.

The thermoformable film may be suitable for thermoforming on form/fill/seal lines in which forming dwell times are short to maintain suitable line speeds. In some embodiments, the thermoformable films described herein are suitable for thermoforming with preheat dwell times of ten seconds or less, such as five seconds or less, two seconds or less, one second or less, or 0.5 seconds or less. Preheating may be completed in one or more sections of an indexing machine and the preheat dwell time may be a summation of the dwell time in the one or more sections including preheating. A thermoforming temperature window of about 5 degrees C. may be considered a practical lower limit for being suitable for thermoforming on high-speed form/fill/seal equipment with such forming dwell times. As described in the Examples below, a polypropylene homopolymer control film had a thermoforming temperature window of about 3 degrees C., which is too low to be practically used for thermoforming on form/fill/seal equipment on a large commercial scale. In some embodiments, the layers or films comprising the layers described herein have a thermoforming temperature window of 5 degrees C. or more, such as 10 degrees C. or more, or 15 degrees C. or more. Such thermoforming temperature windows may permit practical thermoforming on a large commercial scale with short forming dwell times.

The thermoforming temperature window of a film may be determined by visual inspection of articles thermoformed from the films at various temperatures. The minimum temperature of the thermoformed temperature window may be considered the lowest temperature at which a complete, defect free article is formed. The maximum temperature of the thermoforming temperature window may be considered to the temperature at which the thermoformed article begins to melt, deform, or have poor aesthetics.

The thermoformable films described herein have one or more other characteristics suitable for thermoforming. For example, the films may have suitable sag resistance and other properties, such as, for example, toughness or impact strength for practical use in thermoforming. Layers and films comprising sufficiently large elongational viscosities may have sufficient sag resistance for practical use in thermoforming, particular on form/fill/seal equipment. In embodiments, the thermoformable films have an elongational viscosity of 500,000 Pa s or greater in the machine direction, such as 600,000 Pa s or greater, 700,000 Pa s or greater, 800,000 Pa s or greater, 900,000 Pa s or greater, or 1,000,000 Pa s or greater in the machine direction. In embodiments, the thermoformable films have an elongational viscosity of 500,000 Pa s or greater in the transverse direction, such as 600,000 Pa s or greater, 700,000 Pa s or greater, 800,000 Pa s or greater, 900,000 Pa s or greater, or 1,000,000 Pa s or greater in the transverse direction. The layers and films may have an elongational viscosity of 500,000 Pa s or greater in both the machine direction and the transverse direction, such as 600,000 Pas or greater, 700,000 Pa s or greater, 800,000 Pa s or greater, 900,000 Pa s or greater, or 1,000,000 Pa s or greater in both the machine direction and the transverse direction. Elongational viscosity may be measured using a TA Instruments Discovery Hybrid Rheometer (DHR)-2 outfitted with a SER3 universal testing platform.

Elongational viscosity may be measured as follows. Samples may be compression molded from pellets into 2 mm thick films. The pellets may be melted at 210° C. for 5 minutes with the mold resting in contact with both the top and bottom platens. Then, 20,000 lbs of pressure may be applied for 2 minutes. The sample may be removed and placed in a 23° C. press with 10,000 lbs of pressure to cool. Then the sample may be removed from the mold and conditioned for 24 hours at 23° C. with 50% humidity before measuring elongational viscosity. Sample strips measuring 4 mm by 12 mm strips may be cut into the compression molded 2 mm films. These may each be loaded into a TA Instruments DHR-2 hybrid rheometer with a SER3 universal testing platform attachment. The sample may receive a temperature soak of 170° C. for 300 seconds, and then an extensional rate of 0.1 s-1 at 170° C. may be applied until a final strain of 4.0 is reached. The peak elongational viscosity measured according to this method may be reported as the elongational viscosity value. The method and apparatus (Sentmanat Extension Rheometer) for measuring the elongational viscosity are also described in U.S. Pat. Nos. 6,578,413 and 6,691,569, the contents of which are hereby incorporated herein by reference in their respective entireties to the extent that they do not conflict with the disclosure presented herein.

The thermoformable films described herein may comprise any suitable number of layers. In embodiments, the thermoformable film has 2, 3, 4, 5, 6, 7, 8, 9, 10, 11 or more layers. In some embodiments, the thermoformable film has at least three layers.

When the film comprises more than one layer, the exterior (and other) layers are preferably thinner than the interior layer comprising at least 50% PP and (a) the tackifier and/or (b) the COC. The interior layer may have adequate stretching behavior to compensate for deficiencies in other layers (e.g., layers comprising PP but no tackifier or COC). By keeping the other layers thinner, heat may more readily penetrate to the interior layer during thermoforming. In embodiments, the surface layers (or exterior layers) of the film are each about 10% to about 15% of the overall thickness of the film.

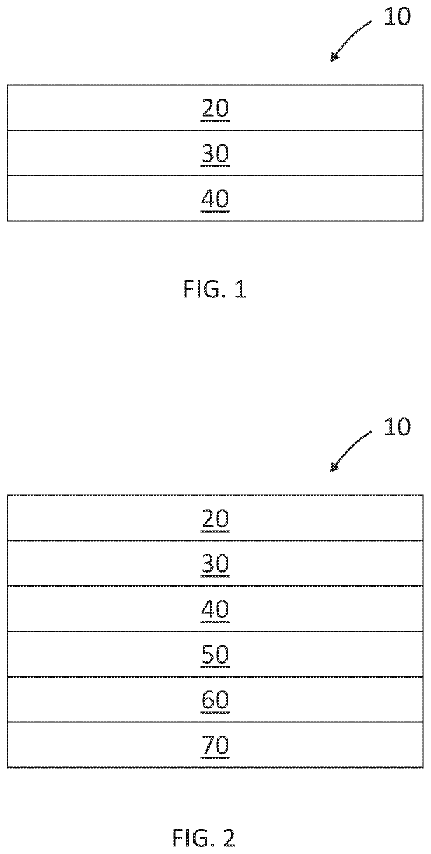

In some embodiments, and with reference to FIG. 1, the thermoformable film 10 comprises three layers: a first layer 20, a second layer 30, and a third layer 40. The second layer 30 is between the first 20 and the third 40 layers. The second layer 30 may comprise at least 50% PP by weight and (a) a tackifier and/or (b) a COC. The second layer 30 may, or may not, comprise a crosslinker. The second layer 30 may, or may not, comprise an impact PP. In some embodiments, the first 20 and the third 40 layers are PP layers. The first 20 and third 40 layers may comprise 50% or more by weight PP, 60% or more by weight PP, 70% or more by weight PP, 80% or more by weight PP, 90% or more by weight PP, or 95% or more by weight PP. In some embodiments, the first 20 and third 40 layers consist of, or consist essentially of, PP. The first 20 and third 40 layers may be the same or different. In some embodiments, the first 20 and third 40 layers are the same compositionally.

In some embodiments, and with reference to FIG. 2, the thermoformable film 10 comprises six layers. The second layer 30 may comprise at least 50% PP by weight and (a) a tackifier and/or (b) a COC. The second layer 30 may, or may not, comprise a crosslinker. The second layer 30 may, or may not, comprise an impact PP. In some embodiments, the first layer 20 and the sixth layer 70 are PP layers. The first 20 and sixth 70 layers may comprise 50% or more by weight PP, 60% or more by weight PP, 70% or more by weight PP, 80% or more by weight PP, 90% or more by weight PP, or 95% or more by weight PP. In some embodiments, the first 20 and sixth 70 layers consist of, or consist essentially of, PP. The first 20 and sixth 70 layers may be the same or different. In some embodiments, the first 20 and sixth 70 layers are the same compositionally.

Still with reference to FIG. 2, the fourth layer 50 may be a barrier layer. In some embodiments, the fourth 50 layer is an EVOH layer. The third 40 and fifth 60 layers may be tie layers. The tie layers may be PP copolymer layers. The third 40 and fifth 60 layers may be the same or different. In some embodiments, the third 40 and fifth 60 layers are the same compositionally.

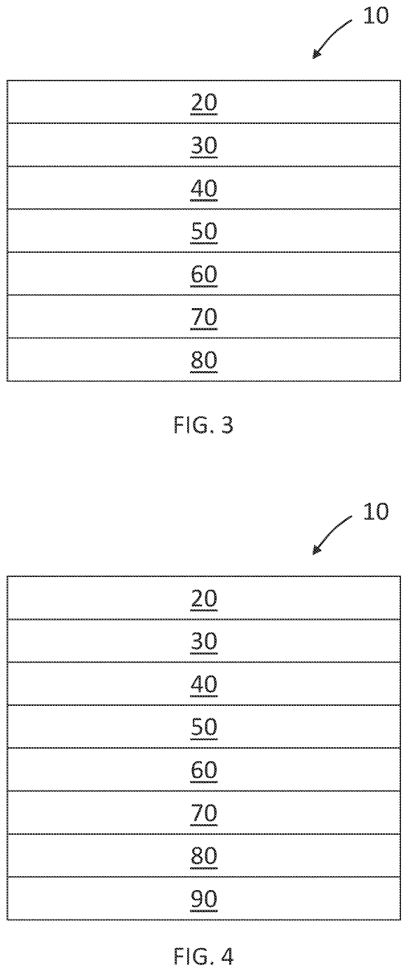

In some embodiments, and with reference to FIG. 3, the thermoformable film 10 comprises seven layers. The second 30 and sixth 70 layers may comprise at least 50% PP by weight and (a) a tackifier and/or (b) a COC. The second 30 and sixth 70 layers may, or may not, comprise a crosslinker. The second 30 and sixth 70 layers may, or may not, comprise an impact PP. The second 30 and sixth 70 layers may be the same or different. In some embodiments, the second 30 and sixth 70 layers are the same. In some embodiments, the first layer 20 and the seventh layer 80 are PP layers. The first 20 and seventh 80 layers may comprise 50% or more by weight PP, 60% or more by weight PP, 70% or more by weight PP, 80% or more by weight PP, 90% or more by weight PP, or 95% or more by weight PP. In some embodiments, the first 20 and seventh 80 layers consist of, or consist essentially of, PP. The first 20 and seventh 80 layers may be the same or different. In some embodiments, the first 20 and seventh 80 layers are the same.

Still with reference to FIG. 3, the fourth layer 50 may be a barrier layer. In some embodiments, the fourth 50 layer is an EVOH layer. The third 40 and fifth 60 layers may be tie layers. The tie layers may be PP copolymer layers. The third 40 and fifth 60 layers may be the same or different. In some embodiments, the third 40 and fifth 60 layers are the same.

In some embodiments, and with reference to FIG. 4, the film 10 comprises eight layers. The second 30 and sixth 70 layers may comprise at least 50% PP by weight and (a) a tackifier and/or (b) a COC. The second 30 and sixth 70 layers may, or may not, comprise a crosslinker. The second 30 and sixth 70 layers may, or may not, comprise an impact PP. The second 30 and sixth 70 layers may be the same or different. In some embodiments, the second 30 and sixth 70 layers are the same. In some embodiments, the first layer 20 is a PP layer. The first layer 20 may comprise 50% or more by weight PP, 60% or more by weight PP. 70% or more by weight PP. 80% or more by weight PP, 90% or more by weight PP, or 95% or more by weight PP.

Still with reference to FIG. 4, the fourth layer 50 may be a barrier layer. In some embodiments, the fourth 50 layer is an EVOH layer. The third 40 and fifth 60 and seventh 80 layers may be tie layers. The tie layers may be PP copolymer layers. The third 40 and fifth 60 and seventh 80 layers may be the same or different. In some embodiments, the third 40 and fifth 60 and seventh 80 layers are the same. The eighth layer 90 may be a seal layer. The seal layer may include polyethylene and/or polypropylene materials. Examples of suitable polymers for a polyethylene seal layer include polyethylene homopolymers, such as low density polyethylene; ethylene α-olefin copolymers, such as linear low density polyethylene; ethylene vinyl acetate copolymers; ethylene alkyl acrylate copolymers, such as ethylene methyl acrylate copolymer; copolymers of ethylene and ethylenically unsaturated carboxylic acids, such as ethylene acrylic acid copolymer and ethylene methacrylic acid copolymer, ionomers, and combinations thereof.

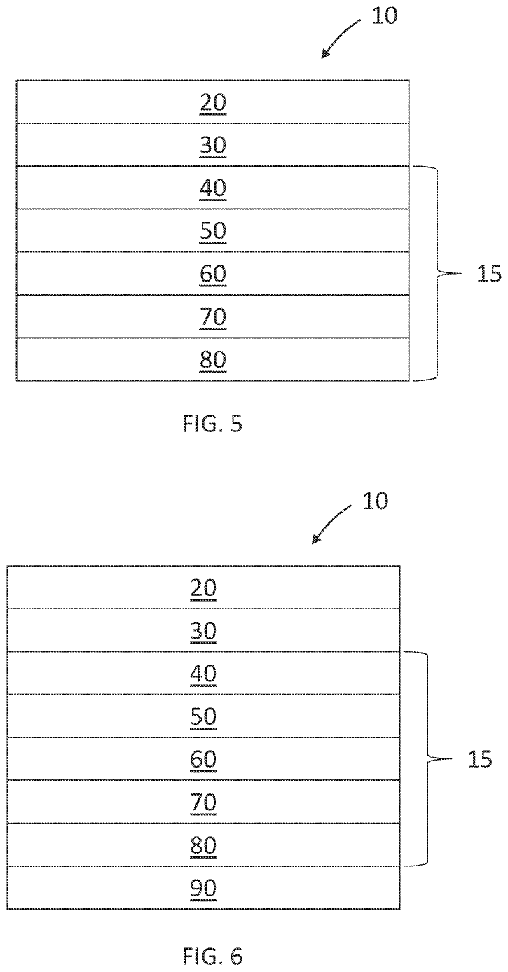

In some embodiments, and with reference to FIG. 5, the film 10 comprises seven layers. The second layer 30 may comprise at least 50% PP by weight and (a) a tackifier and/or (b) a COC. The second layer 30 may, or may not, comprise a crosslinker. The second layer 30 may, or may not, comprise an impact PP. In some embodiments, the first layer 20, the third layer 40, and the seventh layer 80 are PP layers. The first 20, third 40, and seventh 80 layers may be the same or different. In embodiments, the first 20, third 40, and seventh 80 layers are the same. In embodiments, the third 40 and seventh 80 layers are the same. The first layer 20, the third layer 40, and the seventh layer 80 may comprise 50% or more by weight PP, 60% or more by weight PP, 70% or more by weight PP, 80% or more by weight PP, 90% or more by weight PP, or 95% or more by weight PP. In embodiments, the first layer 20, the third layer 40, and the seventh layer 80 consist of, or consist essentially of, PP. The fifth layer 60 may be an EVOH layer. The fourth 50 and sixth 70 layers may be tie layers. The tie layers may be PP copolymer layers. The fourth 50 and sixth 70 layers may be the same or different. In some embodiments, the fourth 50 and sixth 70 layers are the same.

In some embodiments, the third 40 through seventh 80 layers of the film 10 depicted in FIG. 5 may comprise a blown film 15. The blown film 15 may be made in any suitable manner. For example, the blown film 15 may be made by a standard blown film coextrusion process, collapsing the bubble into a single palindromic film. A film comprising the first 20 and second 30 layers may be coated on blown film 15 to produce the final film 10.

In some embodiments, and with reference to FIG. 6, the film 10 comprises eight layers. In embodiments, first 20, second 30, third 40, fourth 50, fifth 60, sixth 70, and seventh 80 layers are the same as depicted in, and discussed regarding, FIG. 5. In some embodiments depicted in FIG. 6, the eight layer 90 is a PP layer. The eighth layer 90 may be the same or different than the first 20 layer. In embodiments, the eight layer 90 is the same as the first layer 20. The eight layer 90 may be coated on the blown film 15.

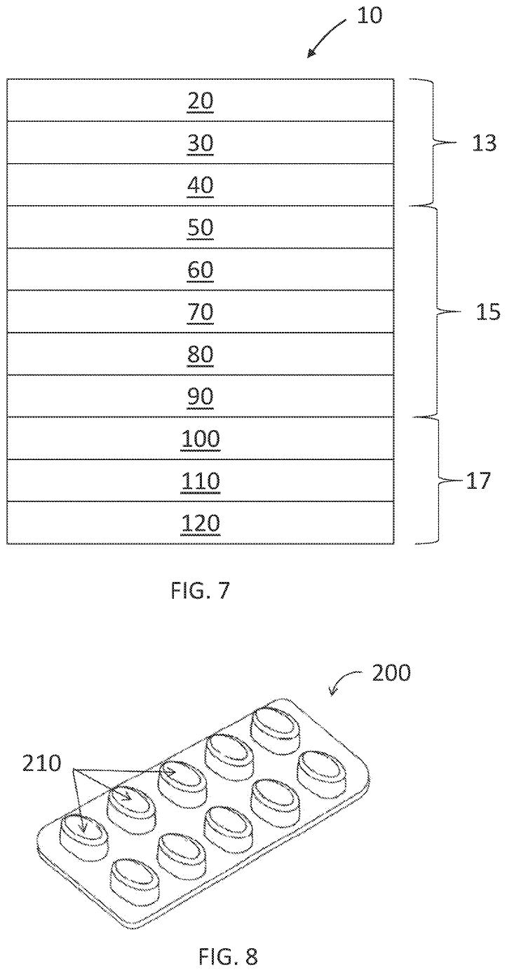

In some embodiments, and with reference to FIG. 7, the film 10 comprises eleven layers. In some embodiments, the film 10 is made by forming a blown film 15 and coating films 13 and 17 on the blown film 15. Film 13 and film 17 may be the same or different. In embodiments, film 13 and film 17 are the same. For example, second layer 30 and the tenth layer 110 may comprise at least 50% PP by weight and (a) a tackifier and/or (b) a COC. The second 30 and tenth 110 layers may, or may not, comprise a crosslinker. The second 30 and tenth 110 layers may, or may not, comprise an impact PP. The second 30 and tenth 110 layers may be the same or different.

In some embodiments, the first 20 and the third 40 layers, and the ninth 100 and eleventh 120 layers, are PP layers. The first 20, third 40, ninth 100, and eleventh 120 layers may comprise 50% or more by weight PP, 60% or more by weight PP, 70% or more by weight PP, 80% or more by weight PP, 90% or more by weight PP, or 95% or more by weight PP. In some embodiments, the first 20, third 40, ninth 100, and eleventh 120 layers consist of, or consist essentially of, PP. The first 20 and third 40 layers, and the ninth 100 and eleventh 120 layers, may be the same or different. In some embodiments, the first 20 and third 40 layers are the same, and the ninth 100 and eleventh 120 layers are the same.

In some embodiments, the fourth 50 through eighth 90 layers of the film 10 depicted in FIG. 5 may comprise a blown film 15. The blown film 15 may be made in any suitable manner. For example, the blown film 15 may be made by a standard blown film coextrusion process, collapsing the bubble into a single palindromic film. For example, the sixth layer 70 may be an EVOH layer, the fifth 60 and seventh 80 layers may be tie layers, which may be PP copolymer layers, and the fourth 50 and eighth 90 layers may be PP layers.

It will be understood that the films 10 depicted in FIGS. 1-7 are just a few of the many possible thermoformable films that may be made in accordance with the teachings provided herein. The films 10 depicted in, and discussed regarding, FIGS. 1-7, as well as many others, may be used as a base film for thermoforming articles, such as packaging components.

### Thermoformed Packaging Components and Packaged Products

The films described herein having a layer comprising at least 50% PP by weight and (a) a tackifier and/or (b) a COC may be a base film suitable for packaging products. A lidding film may be heat sealed to a thermoformed base packaging component made from the thermoformable base film, creating a package that may be accepted in a recycling process. The packaging may be suitable for products such as, but not limited to, pharmaceuticals, nutraceuticals, medical products, fresh foods, refrigerated foods, shelf-stable foods, consumer goods, cosmetics and chemicals.

The packages described herein, incorporate at least two packaging components. First is a thermoformed base component, made from a PP-based film. The thermoformed cavity may be deep or shallow and is generally shaped to hold the intended product therein. The thermoformable base film should be of a thickness to provide for the desired rigidity (i.e., stiffness), durability and barrier upon thermoforming. Second is a lid packaging component. The lid is configured from a film that is capable of being hermetically heat sealed to the thermoformed base component, producing a protective package for the product.

In some embodiments of the package, a lid component having a composition high in PP may be used in conjunction with the thermoformed base. The combination of the thermoformed base component and the lid packaging component may provide a highly homogeneous polymer composition (mostly comprising PP) to provide for the opportunity to recycle the entire package in a single stream.

The packaging components described herein are unique in that they are produced using high levels of PP yet retain high-performance characteristics required for demanding thermoformed packaging applications. The hermetically sealed packages may provide excellent product protection, good appearance, good forming accuracy and consistency, good heat resistance, and good seal strength. Packages with these levels of performance have not previously been delivered using materials that can be easily recycled in the PP recycling stream.

The thermoformable base films may be formed into packaging components (thermoformed bases) and used in conjunction with other packaging components (such as lidding) to produce packaging. Thermoformed bases may be produced from the thermoformable base film by a thermoforming process using heat and pressure (mechanical and/or vacuum). The thermoformed base may be highly rigid and inflexible or the thermoformed base may be flexible while still maintaining the thermoformed shape. The thermoformed bases described herein have at least one cavity to hold a product and a flange surrounding each of the cavities. The flange is generally an unformed area of the film and serves as a place to connect the thermoformed base to the other packaging components, which may be a lid, another thermoformed base component or some other packaging component.

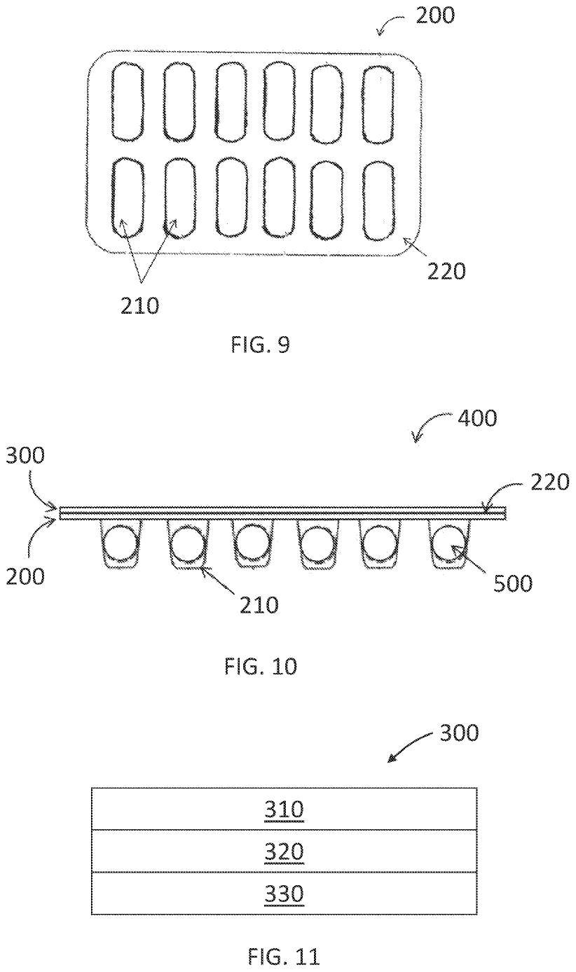

Examples of thermoformed bases are shown in FIGS. 8-10. In the embodiments depicted in FIGS. 8-10, the thermoformed bases 200 have multiple (10 or 12) small cavities 210 surrounded by a flange 220. Cavities such as these may be sized specifically to hold an individual pharmaceutical tablet or capsule. Alternatively, the cavity of the thermoformed base may be large and hold multiple product pieces. Cavities of all numbers, sizes and shapes are anticipated by this disclosure.

Each cavity 210 present is surrounded by a flange 220, as shown in the packaged product embodiment of FIG. 10. The flange 220 of the thermoformed base 200 should be an area without curvature for attachment to another packaging component, such as a lid packaging component 300. There is a product 500 enclosed in each of the cavities. The lid 300 component may be hermetically sealed to the flange 220 in areas surrounding each of the cavities 210 of the thermoformed base 200. Alternatively, the lidding 300 may be connected to the thermoformed base 200 at the flange 220 in an area including the entire perimeter surrounding all the cavities 210, and not between each of the cavities 210.

The thermoformed base may be attached to another packaging component by way of a seal, preferably a hermetic seal. In this manner, the product inside the package is completely enclosed in the cavity and protected by way of the thermoformed base and the other packaging component(s). The exchange of gasses, liquids, microbes or other materials is limited to those that are able to pass through the packaging components, as the hermetic seal does not permit passage in the space between the components.

The product that is contained in the cavities of the thermoformed base is not limited. The product may be sensitive to the environment such as pharmaceuticals or foods. The product may require physical protection, such as delicate medical devices. The product may need to be contained for consumer protection, such as medicaments or cleaners that should be in child proof packaging. The product may be suitable for easy dispensing such as gum or candy.

If a lid packaging component is included in the packaged product, the lid may be of any composition that is suitable for the application. The lid should have a heat sealable exterior layer that is formulated such that it can be readily attached to the thermoformed base by way of heat sealing. The seal between the lid packaging component and the thermoformed base may be peelable (i.e. readily separated manually, with peel strength less than about 2,500 g/in) or fusion.

If the lid is fusion sealed to the thermoformed base, the lid may be formulated and/or designed such that the product can be pushed through the lid for dispensing. Particularly for applications of a packaged product that include pharmaceutical tablets, gum pieces or the like, the cavities of the thermoformed base may flexible enough that a consumer can depress the cavity manually, forcing the product through the lid component, for dispensing.

The lid packaging component may have a moisture and/or oxygen barrier that is similar in performance to the thermoformed base. Materials that are commonly used in high-performance lidding include but are not limited to metal layers or paper layers. The metal and/or paper layers may be laminated or otherwise connected to polymer layers including a heat sealing layer. The lid may be printed, scored or otherwise modified for specific properties.

Any suitable lidding film may be used as a lid for the package. In some embodiments, the lidding film comprises a lidding film exterior layer, a seal layer, and a lidding film interior layer between the lidding film exterior layer and the seal layer. The seal layer may be heat sealed to the thermoformable film to form a sealed package.

The lidding film may comprise any suitable lidding exterior layer. In some embodiments, the lidding exterior layer comprises 50% or more PP by weight, such as 60% or more PP by weight, 70% or more PP by weight, 80% or more PP by weight, 80% or more PP by weight, or 95% or more PP by weight. The lidding exterior layer may consist of or consist essentially of PP. In some embodiments, the lidding exterior layer comprises 99.9% or less PP by weight.

The lidding exterior layer may comprise, or may not comprise, a COC. The lidding exterior layer may comprise any suitable amount of COC. In some embodiments, the COC is present a lidding exterior layer in an amount between about 5% by weight and about 50% by weight, such as from about 10% by weight to about 45% by weight, from about 15% by weight to about 35% by weight, or about 30% by weight.

The lidding interior layer may comprise, or may not comprise, a tackifier. The lidding interior layer may comprise any suitable tackifier. Examples of suitable tackifiers are discussed above under the heading “tackifier.” The lidding interior layer may comprise any suitable amount of tackifier. For example, the lidding interior layer may comprise from 5% to 50% tackifier by weight, 5% to 40% tackifier by weight, 10% to 60% tackifier by weight, 10% to 50% tackifier by weight, 10% to 40% tackifier by weight, 15% to 60% tackifier by weight. 15% to 50% tackifier by weight. 15% to 40% tackifier by weight, 20% to 60% tackifier by weight, 20% to 50% tackifier by weight, 20% to 40% tackifier by weight, 10% to 25% tackifier by weight, 15% to 20% tackifier by weight, or the like.

The lidding seal layer comprises a polyolefin plastomer (POP). A POP is similar to a POE, except that a POP has a higher density that a POP.

The lidding seal layer may comprise any suitable POP. POPs are ethylene-based or propylene-based random copolymers produced from single-site catalysts that bridge the performance gap between conventional polyolefins such as polyethylene or polypropylene and conventional elastomers like ethylene propylene diene monomer (EPDM). See, e.g., Mark, J. (Ed.). (1999). Polymer Data Handbook. Oxford University Press. Any suitable catalyst, such as metallocene catalysts or Ziegler-Natta catalysts, may be used to produce POPs. POPs typically have densities between 0.855 g/cm³ and 0.912 g/cm³. Ethylene-based POPs may have 65% to 91% by weight ethylene and 9% to 35% by weight linear alpha-olefin (LAO). LAO such as butene-1, hexene-1, or octene-1 may be used. Propylene-based POPs typically have 70% to 90% propylene by weight and 10% to 30% by weight ethylene or butene-1. Any suitable processes may be used to produce POPs. Examples of suitable processes include solution processes, gas phase reactor processes, and autoclave processes. In some embodiments, the POE is a propylene-based POP. In some embodiments, the POP comprises a propylene random copolymer. Examples of suitable POPs include grades of Exact (ExxonMobil), Affinity (Dow), Engage (Dow), Versify (Dow), Vistamaxx (ExxonMobil) and Tafmer (Mitsui).

The lidding seal layer may comprise, or may not comprise, a PP copolymer. The lidding seal layer may comprise any suitable PP copolymer. In some embodiments a PP copolymer is formed from polymerization of polypropylene with ethylene or an alpha olefin having from 4 to 12 carbon atoms. In some embodiments, the PP comprises ethylene. In embodiments, the PP comprises a comonomer selected from ethylene and alpha-olefins having from 4 to 12 carbon atoms at a weight percent from about 0.1% to about 20%, such as from about 0.5% to about 15%, about 0.5% to about 10%, about 0.5% to about 8%, 1% to about 15%, about 1% to about 10%, about 1% to about 8%, 2% to about 15%, about 2% to about 10%, or about 2% to about 8%.

PP copolymers as described are also known as random copolymers (RCP). See, e.g., Mark, J. (Ed.). (1999). Polymer Data Handbook. Oxford University Press. In some embodiments, the PP copolymer comprises random copolymers of ethylene or butene-1 with propylene. Heterophasic and impact copolymers are also PP copolymers.

Preferably, a product sealed between the thermoformed base (e.g., the product in the tray) and the lidding may be readily pushed through the lidding.

Preferably, the lidding is free from scoring or lines of weakness.

One example of a lid component that may be sealed to a thermoformed base to provide a packaged product is shown in FIG. 11. The lid 300 may have a lidding exterior layer 310 as described above. The lid 300 may have a lidding interior layer 320 as described above. The lid 300 may have a seal layer 330 as described above.

One advantage to the lid 300 as shown in FIG. 11 is that it would have similar recyclability as compared to the thermoformable base films described herein, such that the entire package could be recycled together without separating.

### Certain Definitions

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open-ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

As used herein, “providing” an article, such as a film, means to make, purchase, or otherwise obtain the article.

The term “layer” refers to a discrete component of a film that has a substantially uniform composition. A layer may or may not be coextensive with the film.

As used herein, a “polymer” refers to a material that is the product of polymerization or copolymerization of natural, synthetic or combined natural and synthetic monomers or co-monomers, or monomers and co-monomers, and is inclusive of homopolymers, copolymers, terpolymers, and the like. A layer may comprise a single polymer, a mixture of a polymer and non-polymeric material, a combination of two or more polymers blended together, or a mixture of two or more polymers and non-polymeric material.

A “polyolefin,” “polyethylene,” “polypropylene,” or “EVOH” are inclusive of not only polymers comprising repeating units derived from monomers known to polymerize to form a polymer of the named type, but are also inclusive of comonomers, as well as both unmodified and modified polymers made by, e.g., derivatization of a polymer after its polymerization to add functional groups or moieties along the polymeric chain. Furthermore, terms identifying polymers are also inclusive of “blends” of such polymers.

Percentages of components in a blend or layer described herein are expressed in percent by weight unless otherwise specified.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

Reference in the specification to “some embodiments,” “an embodiment,” “one embodiment,” “one or more embodiments,” “embodiments,” “other embodiments,” or the like means that a particular feature, structure, or characteristic described in connection with the embodiments is included in at least one or more embodiments, but not necessarily all embodiments, of the present disclosure.

While various features, elements or steps of particular embodiments may be disclosed using the transitional phrase “comprising.” it is to be understood that alternative embodiments, including those that may be described using the transitional phrases “consisting of” or “consisting essentially of,” are implied. Thus, for example, implied alternative embodiments to a film comprising polypropylene, tie, and EVOH layers include embodiments where the film consists of a polypropylene, tie, and EVOH layers and embodiments the film consists essentially of polypropylene, tie, and EVOH layers.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as, an acknowledgment or any form of suggestion that they constitute valid prior art or form part of the common general knowledge in any country in the world.

### EXAMPLES

### Example 1: Single Layer Films Thermoformed on a Lab Line

Single layer sample films were formed from four different blends having a composition as indicated Table 1 below and the sample films were thermoformed by a one-up former in a prototype lab. The one-up former had an infrared oven for heating, which lacked temperature control. The dwell time was used to control the amount of heat received by the films. Once desired dwell time/temperature was reached, a vacuum was engaged to form into the mold.

TABLE 1
Compositions of single layer films

| | Homo | Tackifier | Impact | Crosslinker | COC |
|---|---|---|---|---|---|
| Film | PP % | % | PP % | % | % |
| 1 | 100 | — | — | — | — |
| 2 | 70 | 20 | 10 | — | — |
| 3 | 68.5 | 20 | 10 | 1.5 | — |
| 4 | 80 | — | — | — | 20 |

Homo PP = Braskem INSPIRE 6021N, Tackifier = Plastolyn ® R1140 Hydrocarbon Resin available from Synthomer plc, Impact PP = LyondellBasell Adflex Q100F, Crosslinker = DYMALINK ® 9200 ionomeric diacrylate functional monomer available from Total (TotalEnergies), COC = Topas ® 5013F-04 from Topas Advanced Polymers.

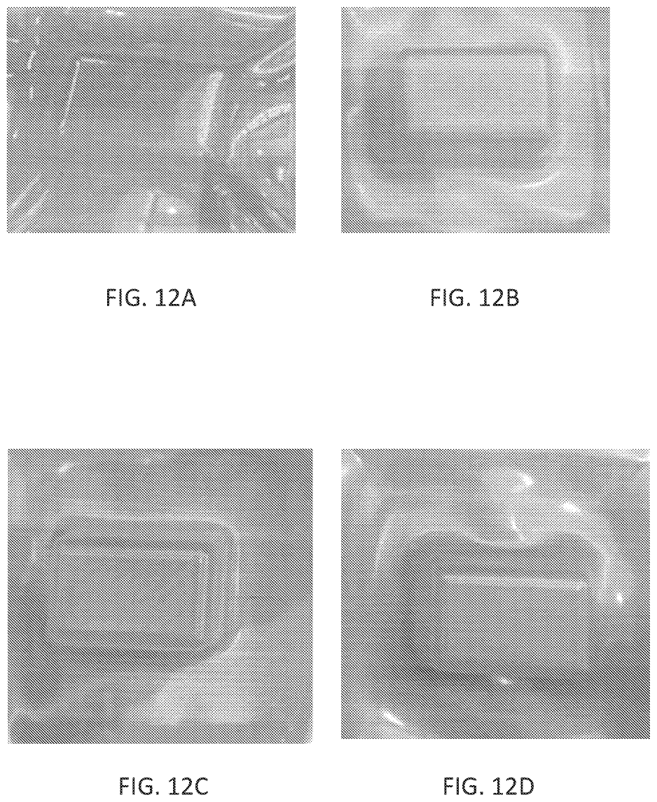

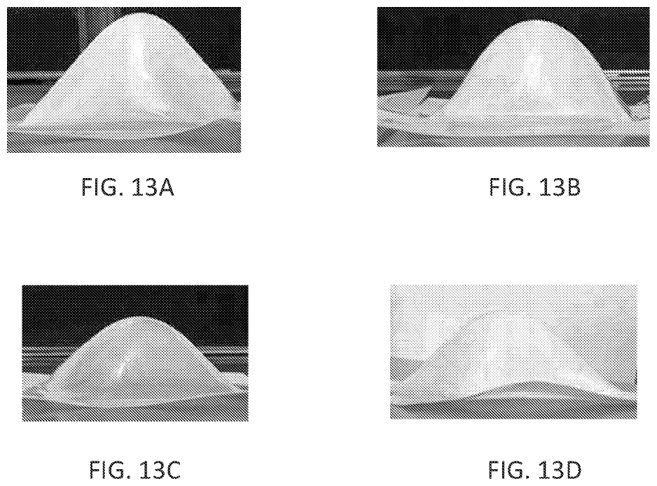

Trays were thermoformed from the films on the one-up former using a 7 second dwell time for each film. Images of the resulting trays are shown in FIGS. 12A (film 1), 12B (film 2), 12C (film 3), and 12D (film 4). As shown in FIGS. 12A-D, the sample containing tackifier (FIG. 12B, film 2) resulted in substantially improved tray formation relative to the control sample (FIG. 12A, film 1) indicating improved thermoformability. The tray formed from the sample containing COC (FIG. 12D, film 4) appeared slightly more well-defined than the tray formed from the sample containing tackifier (FIG. 12B, film 2). The tray formed from the sample containing tackifier and crosslinker (FIG. 12C, film 3) appeared the most well-defined, with details on the bottom of the tray being visible.

Sag resistance of the four films was tested as follows. The film samples were baked in oven for extended time to evaluate its sagging resistance. Once removed from the oven, the samples were cooled for 3 minutes to allow a drape to fully form. Images of the films are shown in FIGS. 13A (film 1), 13B (film 2), 13C (film 3), and 13D (film 4) for which the dwell times were 38 seconds. The depth of the drape was measured as an indicator of sag resistance of each film. The sag resistance. Similar to the trays illustrated in FIGS. 12A-D, the film with the tackifier and crosslinker (film 3) had the best sag resistance, followed by the film with COC (film 4), the film with the tackifier (film 2), and the control film (film 1).

With the help of the crosslinker or amorphous COC, melt strength improves for films 2-4, so does the sagging resistance.

### Example 2: Multilayer Films Thermoformed on a Commercial Line and Determining Thermoforming Temperature Window

Seven-layer films with different PP blends (the blends listed in Table 1 above for films 1, 2, 3, and 4) were made by coextrusion. The seven layers of the films were as follows: (1) 10% PP homopolymer (6021N), (2) 35% PP blend (1/2/3/4 blend), (3) 2.5% tie, (4) 5% EVOH, (5) 2.5% tie, (6) 35% PP blend (1/2/3/4 blend), and (7) 10% PP homopolymer (6021N). The films were subjected to thermoforming on a Bosch line former. Temperature zones 1 and 2 were set to 60° C. for all films, and only zones 3, 4, & 5 were adjusted throughout the trial. Each film was run with a similar preheat plate dwell for consistency and comparison (1.64 seconds, top/1.25 seconds, bottom). Air pressure was kept between 65-85 psi and adjusted only as needed to optimize appearance for every film/temperature combination. The quality of the thermoformed article was visually inspected and determine to be suitable or unsuitable. The temperature ranges determined to be suitable for thermoforming for each of the tested films is shown below in Table 2.

TABLE 2
Thermoforming temperature windows

| Film Composition | Thermoforming Temperature Window (C.) |
|---|---|
| 1 | 162 to 165 |
| 2 | 150 to 160 |
| 3 | 150 to 165 |
| 4 | 155 to 165 |

As shown in Table 2, each of the sample films containing a blend (2-4) increased the thermoforming temperature window relative to the sample film containing a homopolymer PP (with no tackifier, no crosslinker, no impact PP, and no COC) from three 3 degrees C. (162 to 165) to 10 degrees C. (150 to 160 or 155 to 165) or 15 degrees C. (150 to 165). The broadest thermoforming temperature window was obtained with the blend comprising the tackifier and the crosslinker (film 3). A 10 degree C. thermoforming temperature window is sufficiently large to allow for practical use of the films to produce thermoformed articles on form/fill/seal lines.

Thermoforming temperature windows were determined by visual inspection of thermoformed cups for defects at various temperatures. Those temperature for which high quality cups were formed are included in the ranges in Table 2 above.

### Embodiments

System Embodiment A: A system for forming a blister package, the system comprising:
   a thermoformable film comprising a thermoformable film exterior layer and a thermoformable film interior layer,
      the thermoformable film exterior layer comprising at least 50% by weight polypropylene,
      the thermoformable film interior layer comprising at least 50% by weight polypropylene and (a) a tackifier and/or (b) a cyclic olefin copolymer; and
   a lidding film comprising a lidding film exterior layer, a lidding film interior layer, and a seal layer,
      the lidding film exterior layer comprising at least 50% polypropylene,
      the lidding film interior layer comprising at least 50% polypropylene and a tackifier,
      the seal layer comprising a polyolefin plastomer.
System Embodiment B: The system of System Embodiment A, wherein the thermoformable film interior layer comprises at least 5% by weight of the tackifier.
System Embodiment C: The system of System Embodiment A or B, wherein the thermoformable film interior layer comprises from 5% to 40% tackifier by weight.
System Embodiment D: The system of System Embodiment A or B, wherein the thermoformable film interior layer comprises from 10% to 25% tackifier by weight.
System Embodiment E: The system of System Embodiment A or B, wherein the thermoformable film interior layer comprises from 15% to 20% tackifier by weight.
System Embodiment F: The system of any previous System Embodiment, wherein the thermoformable film interior layer further comprises a crosslinker.
System Embodiment G: The system of System Embodiment F, wherein the thermoformable film interior layer comprises from 0.5% by weight to 5% by weight of the crosslinker.
System Embodiment H: The system of System Embodiment F, wherein the thermoformable film interior layer comprises from 1% to 3% of the crosslinker.
System Embodiment I: The system of any one of System Embodiments F through H, wherein the crosslinker is an ionic crosslinker.
System Embodiment J: The system of any previous System Embodiment, wherein the thermoformable film interior layer comprises from 5% by weight to 40% by weight of the cyclic olefin copolymer.
System Embodiment K: The system of any previous System Embodiments, wherein the thermoformable film exterior layer further comprises a polyolefin elastomer.
System Embodiment L: The system of System Embodiment K, wherein the polyolefin elastomer comprises a propylene random copolymer.
System Embodiment M: The system of any previous System Embodiment, wherein the lidding film exterior layer further comprises a cyclic olefin copolymer.
System Embodiment N: The system of System Embodiment M, wherein the lidding film exterior layer comprises from 5% by weight to 50% by weight of the cyclic olefin copolymer.
System Embodiment O: The system of any previous System Embodiment, wherein the seal layer further comprises a polypropylene copolymer.
System Embodiment P: The system of any previous System Embodiment, wherein the polyolefin plastomer of the seal layer comprises a propylene random copolymer.
Method Embodiment A: A method comprising:
   providing the system of any previous System Embodiment;
   thermoforming a tray from the thermoformable film; and
   heat sealing the lidding film to the tray.
Method Embodiment B: The method of Method Embodiment A, wherein thermoforming the tray comprises thermoforming a blister pack tray.
Method Embodiment C: The method of Method Embodiment A or B, further comprising placing a product in the tray prior to heat sealing the lidding film to the tray.
Blister Pack Embodiment A: A blister pack comprising:
   a tray thermoformed from the thermoformable film of the system of any previous System Embodiment; and
   a lidding sealed to the tray, wherein the lidding is formed from the lidding film of the system of any previous System Embodiment.
Blister Pack Embodiment B: The blister pack of Blister Pack Embodiment A, wherein the lidding is free from scoring or lines of weakness.
Blister Pack Embodiment C: The blister pack of Blister Pack Embodiment A or B, further comprising a product sealed between the tray and the lidding.
Blister Pack Embodiment D: The blister pack of Blister Pack Embodiment C, wherein the product may be readily pushed through the lidding.

1. A system for forming a blister package, the system comprising:
a thermoformable film comprising a thermoformable film exterior layer and a thermoformable film interior layer,
the thermoformable film exterior layer comprising at least 50% by weight polypropylene,
the thermoformable film interior layer comprising at least 50% by weight polypropylene and (a) a tackifier and/or (b) a cyclic olefin copolymer; and
a lidding film comprising a lidding film exterior layer, a lidding film interior layer, and a seal layer,
the lidding film exterior layer comprising at least 50% by weight polypropylene,
the lidding film interior layer comprising at least 50% by weight polypropylene and a tackifier,
the seal layer comprising a polyolefin plastomer.

2. The system of claim 1, wherein the thermoformable film interior layer comprises at least 5% by weight of the tackifier.

3. The system of claim 1, wherein the thermoformable film interior layer comprises from 5% to 40% tackifier by weight.

4. The system of claim 1, wherein the thermoformable film interior layer comprises from 10% to 25% tackifier by weight.

5. The system of claim 1, wherein the thermoformable film interior layer comprises from 15% to 20% tackifier by weight.

6. The system of claim 1, wherein the thermoformable film interior layer further comprises a crosslinker.

7. The system of claim 6, wherein the thermoformable film interior layer comprises from 0.5% by weight to 5% by weight of the crosslinker.

8. The system of claim 6, wherein the thermoformable film interior layer comprises from 1% to 3% of the crosslinker by weight.

9. The system of claim 6, wherein the crosslinker is an ionic crosslinker.

10. The system of claim 1, wherein the thermoformable film interior layer comprises from 5% by weight to 40% by weight of the cyclic olefin copolymer.

11. The system of claim 1, wherein the thermoformable film exterior layer further comprises a polyolefin elastomer.

12. The system of claim 11, wherein the polyolefin elastomer comprises a propylene random copolymer.

13. The system of claim 1, wherein the lidding film exterior layer further comprises a cyclic olefin copolymer.

14. The system of claim 13, wherein the lidding film exterior layer comprises from 5% by weight to 50% by weight of the cyclic olefin copolymer.

15. The system of claim 1, wherein the seal layer further comprises a polypropylene copolymer.

16. The system of claim 1, wherein the polyolefin plastomer of the seal layer comprises a propylene random copolymer.

17. (canceled)

18. (canceled)

19. (canceled)

20. (canceled)

21. (canceled)

22. (canceled)

23. (canceled)
